(19) United States
(12) Patent Application Publication
(10) Pub. No.: US 2025/0104557 A1
(43) Pub. Date: Mar. 27, 2025

(54) System and Method for Clearing a Path for Emergency Vehicles

(71) Applicant: Vincent Loccisano, Wellesley, MA (US)

(72) Inventor: Vincent Loccisano, Wellesley, MA (US)

(21) Appl. No.: 18/969,701

(22) Filed: Dec. 5, 2024

(51) Int. Cl. G08G 1/0967; G08G 1/087; G08G 1/0965; H04W 4/46; H04W 4/90

(52) U.S. Cl. CPC G08G 1/096725; G08G 1/087; G08G 1/0965; G08G 1/096766; H04W 4/46; H04W 4/90

(57) ABSTRACT

The present invention introduces a system and method to dynamically control autonomous vehicles on roadways to create a clear path for approaching emergency vehicles. V2V and V2I communication systems transmit real-time information relating to the location and path of an emergency vehicle to nearby driver-controlled and autonomous vehicles. Upon receiving the information, autonomous vehicle control electronics execute specific maneuvers, while driver-controlled vehicles receive prompts; such as yielding right-of-way, changing lanes or temporarily halting, to create a clear passage for an emergency vehicle. This coordinated effort significantly reduces response time while improving safety.

### BACKGROUND OF THE INVENTION

Emergency situations such as accidents, fires and medical emergencies demand rapid response from emergency vehicles. Traditional traffic-management systems often prove inadequate in quickly clearing a path for these vehicles. This is of particular concern during peak hours or in congested urban areas. Any delay can impact the outcome of an emergency. There is a growing need for solutions that can expedite the movement of emergency vehicles through traffic.

Current technologies in this field include Vehicle-To-Vehicle (V2V) and Vehicle-To-Infrastructure (V2I) communication. V2V communication enables vehicles to exchange real-time information. Dedicated Short-Range Communication (DSRC) allows vehicles to wirelessly share critical data such as speed, location, braking status and turn signals. This information exchange enables a vehicle to anticipate potential hazards, react quickly to changing road conditions, and ultimately improve road safety and speed through traffic.

Vehicle-to-Infrastructure (V2I) communication involves the wireless exchange of information between vehicles and roadside infrastructure such as traffic lights, road signs, and traffic-management centers. V2I technology enables vehicles to receive information about traffic conditions, road hazards and other information. V2I can warn drivers and autonomous vehicles of upcoming traffic jams, construction zones, or accidents. V2I can help optimize traffic flow by coordinating traffic signals or by reacting to traffic signals altered by signals from emergency vehicles.

Traffic infrastructure may include traffic light control systems, toll plazas, and central authorities that control traffic appliances directly or remotely.

### SUMMARY OF THE INVENTION

The present invention introduces a system and method to dynamically control autonomous vehicles on roadways to create a clear path for approaching emergency vehicles. V2V and V2I communication systems transmit real-time information about the location and path of an emergency vehicle to nearby vehicles equipped with appropriate V2V and/or V2I communication electronics. Although autonomous vehicles are commonly equipped with V2V and V2I communication electronics, some modern vehicles are similarly equipped.

In some embodiments information received by a first vehicle may be sent on to other vehicles in proximity, or to distant vehicles to provide an option of avoiding the emergency route. In yet other embodiments emergency vehicles broadcast signals to traffic infrastructure indicating an intended route and estimated arrival time at intersections or other traffic lights and traffic obstacles. In this embodiment a path is cleared for an emergency vehicle ahead of its arrival at a traffic obstacle. In these embodiments a broadcast signal may be peer-to-peer between an emergency vehicle and a vehicle or between a first vehicle and additional vehicles; or may be a broadcast signal to all vehicles and to all traffic infrastructure devices.

In an example embodiment, upon receiving the information, vehicle control electronics may alert a driver to execute specific maneuvers, such as yielding right-of-way, changing lanes or temporarily halting, to create a clear passage for an emergency vehicle.

In other embodiments, upon receiving the information, autonomous-vehicle control electronics execute specific maneuvers, such as yielding right-of-way, changing lanes or temporarily halting, to create a clear passage for an emergency vehicle. Information may be passed by way of V2V or V2I communication between autonomous vehicles and driver-controlled vehicles interchangeably. This coordinated effort significantly reduces response time while improving safety.

### BRIEF DESCRIPTION OF DRAWINGS

FIG. 1 is a diagram of an example embodiment of the disclosure.

### DETAILED DESCRIPTION

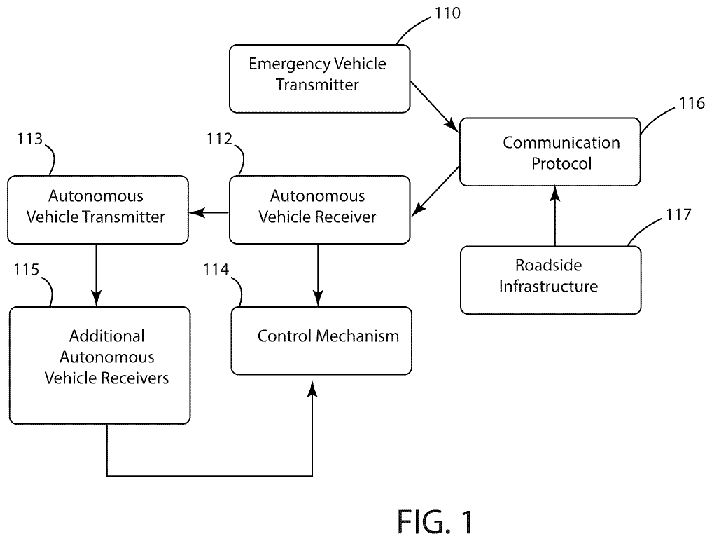

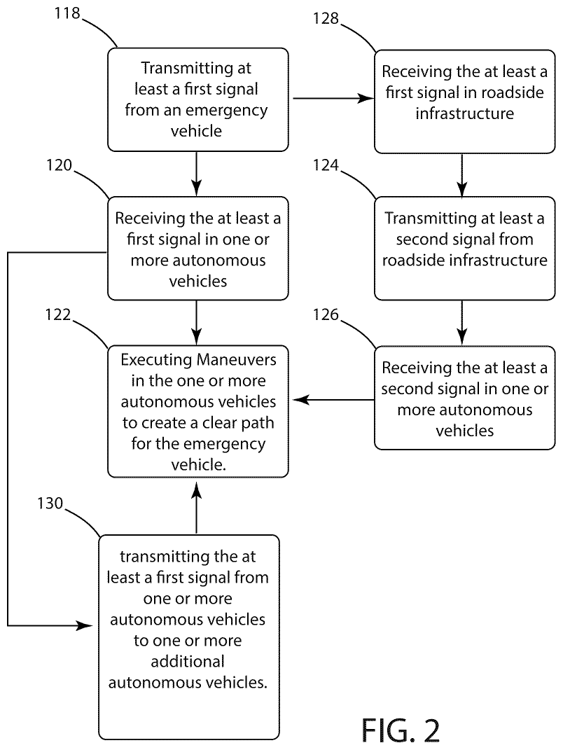

FIG. 1 is a diagram depicting an example embodiment of the disclosure. An emergency vehicle transmitter 110, which comes standard in emergency vehicles, transmits signals defining the location and route of an emergency vehicle in transit. The signal may include the location, direction, speed, route, and trajectory of an emergency vehicle. A communication protocol 116 receives and transmits signals between emergency vehicles and both driver-controlled and autonomous vehicles through a dedicated communication protocol. The protocol ensures low-latency, high-reliability communication that is essential for real-time response. A vehicle receiver 112, equipped in some driver-controlled vehicles and all autonomous vehicles, receives the signals from the emergency vehicle transmitter 110 by way of the communication protocol 116. This communication determines the proximity and direction of the emergency vehicle. The vehicle receiver 112 may also be coupled with a vehicle transmitter 113 that may then send the same signals to additional vehicle receivers 115 by way of V2V communication channels, which in turn inform a control mechanism 114.

In some embodiments, the control mechanism 114 processes the signals from the vehicle receiver 112/115 which in turn has received signals from an emergency vehicle transmitter 110 or roadside infrastructure 117, to determine an optimal response. Algorithms and artificial intelligence calculate the best maneuver to clear the path for the oncoming emergency vehicle. The calculated maneuver may involve pulling over to the side of the road, changing lanes or temporarily stopping. A coordinated response is calculated among multiple driver-controlled and autonomous vehicles to avoid collisions and to ensure a smooth clearance of a path for the emergency vehicle. The calculated response is sent to driver-controlled vehicles in the form of prompts that follow a recommended course of action. The calculated response is sent to autonomous vehicles as commands to control the vehicles.

In another embodiment, roadside infrastructure 117 is configured to send a second signal from roadside infrastructure such as traffic lights, road signs, and traffic-management centers. This technology enables vehicles to receive information relating to traffic conditions, road hazards and other information. V2I can warn drivers and autonomous vehicles of upcoming traffic jams, construction zones, or accidents.

The system may be implemented into existing, modern vehicle control systems with minimal modification. Emergency vehicles are equipped with a vehicle transmitter 110 which automatically activates when responding to an emergency.

FIG. 2 is a diagram of a method for implementing the system of FIG. 1. The method begins by transmitting a first signal from an emergency vehicle 118 and then receiving at least a first signal in one or more vehicles 120, and follows, in some embodiments, by executing maneuvers in the autonomous vehicle, or by sending prompts to a driver-controlled vehicle 122. in other embodiments receiving the at least a first signal in one or more vehicles 120 is followed by the step of transmitting the at least a first signal from one or more vehicles to one or more additional vehicles 130. In each case the receipt of signals follows to executing maneuvers or driver prompts, in one or more driver-controlled or autonomous vehicles to create a clear path for the emergency vehicle.

In another embodiment, the method includes transmitting a second signal from roadside infrastructure 124 and then receiving the second signal in one or more vehicles 126 before prompting a driver or executing maneuvers 122.

1. A system for an emergency vehicle comprising:
a transmitter in the emergency vehicle configured to send at least a first signal indicating its presence and route; and
a receiver in at least one vehicle, the receiver configured to receive the at least a first signal; and
control algorithms in the vehicle configured to define maneuvers that clear a path for the emergency vehicle.

2. The system of claim 1 wherein:
the at least one vehicle is an autonomous vehicle; and
control algorithms in the autonomous vehicle are configured to define and execute maneuvers that clear a path for the emergency vehicle.

3. The system of claim 1 further comprising:
a dedicated communication protocol configured to handle wireless communication of the at least a first signal sent from the transmitter to the receiver.

4. The system of claim 1 wherein:
the control algorithms calculate optimal maneuver based on information included in the at least a first signal wherein;
information in the at least a first signal includes position, speed and trajectory of the emergency vehicle and surrounding autonomous vehicles.

5. The system of claim 1 further comprising;
roadside infrastructure configured to send at least a second signal to at least one vehicle, including information regarding traffic lights, road signs, and information generated by traffic management centers.

6. The system of claim 1 further comprising:
a transmitter in the vehicle configured to send at least a first signal indicating its presence and route and maneuvers that clear a path for the emergency vehicle, to at least one additional vehicle.

7. The system of claim 5 further comprising:
at least one receiver in said roadside infrastructure configured to receive the at least a first signal, coupled with algorithms that control traffic lights; wherein
a path is cleared through traffic ahead of the arrival of the emergency vehicle.

8. A method for clearing a path for an emergency vehicle comprising:
transmitting a signal from the emergency vehicle; and
receiving the signal in at least one autonomous vehicle; and
executing maneuvers in the at least one autonomous vehicle to create a clear path for the emergency vehicle.

9. The method of claim 8 further comprising:
transmitting the signal through a dedicated communication protocol; and
receiving the signal through the dedicated communication protocol.

10. The method of claim 8 further comprising:
calculating optimal maneuvers to create a clear path for the emergency vehicle prior to executing the maneuvers.

11. The method of claim 8 further comprising:
receiving at least a second signal from roadside infrastructure wherein;
the at least a second signal from roadside infrastructure includes information regarding traffic lights, road signs, and information generated by traffic management centers.

12. A method for clearing a path for an emergency vehicle comprising:
transmitting a signal from the emergency vehicle; and
receiving the signal in at least one vehicle; and
prompting maneuvers in the at least one vehicle to create a clear path for the emergency vehicle.

13. The method of claim 12 further comprising:
transmitting the signal through a dedicated communication protocol; and
receiving the signal through the dedicated communication protocol.

14. The method of claim 12 further comprising:
calculating optimal maneuvers to create a clear path for the emergency vehicle prior to prompting the maneuvers.

15. The method of claim 12 further comprising:
receiving at least a second signal from roadside infrastructure wherein;
the at least a second signal from roadside infrastructure includes information regarding traffic lights, road signs, and information generated by traffic management centers.
